(19) United States
(12) Patent Application Publication
(10) Pub. No.: US 2026/0253494 A1
(43) Pub. Date: Aug. 27, 2026

(54) VEHICLE

(71) Applicant: TOYOTA JIDOSHA KABUSHIKI KAISHA, Toyota-shi (JP)

(72) Inventors: Tatsuya SUGANO, Seto-shi (JP); Hidenobu KINUGASA, Nagoya-shi (JP); Takahiro YAMAMOTO, Toyota-shi (JP); Kazuhito ESHIMA, Toyota-shi (JP)

(73) Assignee: TOYOTA JIDOSHA KABUSHIKI KAISHA, Toyota-shi (JP)

(21) Appl. No.: 19/447,422

(22) Filed: Jan. 13, 2026

(30) Foreign Application Priority Data
Feb. 27, 2025 (JP) 2025-030402

(51) Int. Cl. G08G 1/14; B60W 30/06; B62D 15/02

(52) U.S. Cl. CPC G08G 1/142; B60W 30/06; B62D 15/0285

(57) ABSTRACT

A vehicle supporting automated valet parking (AVP) in a parking lot includes: a first controller configured to control an operation of the vehicle; and a second controller configured to receive information transmitted from a parking lot system managing the AVP before the first controller. A time synchronization request is transmitted from the parking lot system to the vehicle in order to know a clock of the vehicle. The second controller acquires and retains seed information before reception of the time synchronization request, the seed information being required in error detection for verification of the time synchronization request. Upon receiving the time synchronization request from the parking lot system, the second controller verifies the time synchronization request through the error detection based on the seed information and returns a response to the time synchronization request back to the parking lot system.

### CROSS-REFERENCES TO RELATED APPLICATION

The present disclosure claims priority to Japanese Patent Application No. 2025-030402, filed on February 27, 2025, the contents of which application are incorporated herein by reference in their entirety.

### TECHNICAL FIELD

The present disclosure relates to automated valet parking (AVP: Automated Valet Parking) of a vehicle in a parking lot.

### BACKGROUND ART

Patent Literature 1 discloses automated valet parking in a parking lot. A vehicle that supports the automated valet parking acquires route information from a parking lot system and autonomously travels along the acquired route.

Non-Patent Literature 1 discloses a standard related to automated valet parking.

### List of Related Art

Patent Literature 1: German Patent Application Publication No. 102012222562

Non-Patent Literature 1: "Automated Valet Parking Systems, Requirements for automated valet parking systems", German Association of the Automotive Industry, Version 1.0, March 2023

### SUMMARY

In automated valet parking, it is desired to know a relationship between a clock of a vehicle and a clock of a parking lot system (infrastructure system). For this purpose, a request for knowing the clock of the vehicle may be transmitted from the parking lot system to the vehicle. At this time, it is desirable that the vehicle quickly responds to the request from the parking lot system.

An aspect of the present disclosure relates to a vehicle that supports automated valet parking in a parking lot.

The vehicle includes:

a first controller configured to control an operation of the vehicle; and

a second controller configured to receive information, which is transmitted from a parking lot system that manages the automated valet parking in the parking lot, before the first controller.

A time synchronization request is a request transmitted from the parking lot system to the vehicle in order to know a clock of the vehicle.

The second controller acquires and retains seed information before reception of the time synchronization request, the seed information being required in error detection for verification of the time synchronization request.

The second controller is configured to, upon receiving the time synchronization request from the parking lot system, verify the time synchronization request through the error detection based on the seed information and return a response to the time synchronization request back to the parking lot system.

According to the present disclosure, the second controller receives the information transmitted from the parking lot system before the first controller. Upon receiving the time synchronization request from the parking lot system, the second controller verifies the time synchronization request based on the seed information and returns a response to the time synchronization request back to the parking lot system. Therefore, the time from the reception of the time synchronization request to the response is shortened as compared with a case where the first controller verifies the time synchronization request and responds to the time synchronization request. That is, the vehicle is able to quickly responds to the time synchronization request from the parking lot system.

### BRIEF DESCRIPTION OF DRAWINGS

FIG. 1 is a conceptual diagram illustrating an overview of an automated valet parking system (AVP system);

FIG. 2 is a conceptual diagram for explaining an example of automated valet parking;

FIG. 3 is a conceptual diagram for explaining an outline of processing related to a time synchronization request;

FIG. 4 is a conceptual diagram for explaining checksum verification of a time synchronization request;

FIG. 5 is a conceptual diagram for explaining a comparative example;

FIG. 6 is a conceptual diagram for explaining an in-vehicle process;

FIG. 7 is a conceptual diagram for explaining an example of preparation of seed information;

FIG. 8 is a conceptual diagram for explaining an in-vehicle communication verification process;

FIG. 9 is a conceptual diagram showing an example of a cooperation between a vehicle identification process and processing related to a time synchronization request;

FIG. 10 is a block diagram showing an example of a configuration of a vehicle; and

FIG. 11 is a block diagram showing an example of a configuration of a parking lot system.

### DETAILED DESCRIPTION

Embodiments of the present disclosure will be described with reference to the accompanying drawings. In the following description, automated valet parking may be referred to as "AVP".

### 1. Automated Valet Parking System AVP System

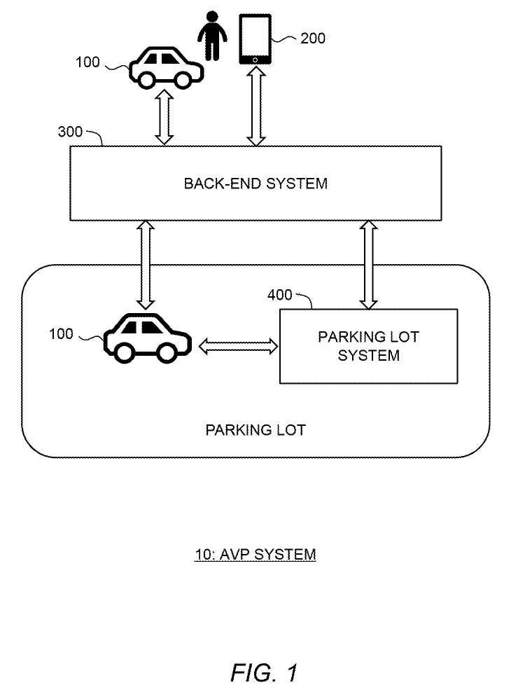

FIG. 1 is a conceptual diagram illustrating an overview of an AVP system 10 according to the present embodiment. The AVP system 10 is a system for the AVP in a parking lot. The AVP system 10 includes a vehicle 100, a user terminal 200, a back-end system 300, and a parking lot system 400.

The vehicle 100 is a target of the AVP in the parking lot and supports the AVP in the parking lot. The vehicle 100 has a function of autonomously traveling at least in the parking lot.

The user terminal 200 is a terminal operated by a user of the AVP service, that is, a user of the vehicle 100. Examples of the user terminal 200 include a smartphone and a PC.

The back-end system 300 manages the AVP in one or more parking lots, users of the AVP service, the vehicles 100 being targets of the AVP, and the like. The parking lot system 400, which is an infrastructure system installed in a parking lot, manages the AVP in the parking lot. The back-end system 300 and the parking lot system 400 may be collectively referred to as a "management system." The management system manages the AVP in the parking lot.

The vehicle 100 and the back-end system 300 can communicate with each other. For example, the vehicle 100 and the back-end system 300 communicate with each other using a mobile communication service. In the parking lot, the vehicle 100 and the parking lot system 400 can perform a wireless communication with each other. For example, the vehicle 100 and the parking lot system 400 perform a wireless communication with each other using a wireless LAN. Moreover, the user terminal 200 and the back-end system 300 can communicate with each other. For example, the user terminal 200 and the back-end system 300 communicate with each other using a mobile communication service. Further, the back-end system 300 and the parking lot system 400 may communicate with each other in a wired or wireless manner.

An example of a flow of a reservation of the AVP service is as follows. It is assumed that member information of the users is registered in advance in the back-end system 300. First, a user makes a reservation of the AVP. For example, the user operates the user terminal 200 to input ID information of the user, a desired parking lot, a desired date of use, a desired time of use (i.e, a scheduled entry time and a scheduled exit time), and the like. The user terminal 200 transmits reservation request information including the input information to the back-end system 300. The back-end system 300 executes reservation processing based on the reservation request information, and sends a reservation completion notification to the user terminal 200. In addition, the back-end system 300 provides reservation information to the parking lot system 400 of the reserved parking lot.

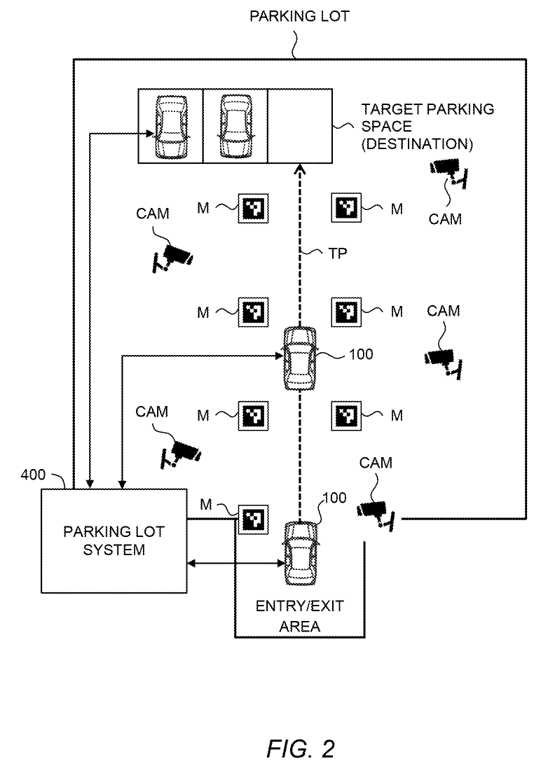

FIG. 2 is a conceptual diagram for explaining an example of the AVP in the parking lot.

The vehicle 100 recognizes a situation around the vehicle 100 by using a recognition sensor (for example, a camera) mounted on the vehicle 100. The vehicle 100 travels safely while recognizing the surrounding situation. A plurality of markers M (landmarks) may be arranged in the parking lot. The marker M is used for guiding the vehicle 100 in the parking lot. For example, the vehicle 100 acquires an image of the surroundings using the camera, and recognizes the marker M based on the image. Then, based on a result of recognition of the marker M, the vehicle 100 performs localization processing that estimates a position of the vehicle 100 in the parking lot with high accuracy. The vehicle 100 automatically travels in the parking lot based on the estimated vehicle position.

One or more infrastructure cameras CAM may be installed in the parking lot. The infrastructure camera CAM captures an image of the parking lot and acquires an image showing a situation of the parking lot. The parking lot system 400 communicates with the infrastructure camera CAM to acquire the image captured by the infrastructure camera CAM. The parking lot system 400 analyzes the image to detect the vehicle 100 shown in the image. Moreover, the parking lot system 400 estimates a position of the vehicle 100 shown in the image. Further, the parking lot system 400 manages the vehicle 100 in the parking lot based on the position of the vehicle 100. The parking lot system 400 may provide the vehicle 100 with the position information of the vehicle 100. The vehicle 100 may automatically travel in the parking lot based on the position information provided from the parking lot system 400.

An example of an entry process (check-in) is as follows. The vehicle 100 stops at an entry area. At the entry area, the user gets off the vehicle 100 and requests the entry by using the user terminal 200 or the like. The management system (i.e., at least one of the back-end system 300 and the parking lot system 400) conducts authentication of the user and the vehicle 100. Upon completion of the authentication, authority to operate the vehicle 100 is transferred from the user to the management system. The management system communicates with the vehicle 100 and activates the vehicle 100. Moreover, the parking lot system 400 allocates an available parking space to the vehicle 100. The allocated available parking space is a target parking space, that is, a destination for the vehicle 100 at the time of the entry. Further, the parking lot system 400 sets a travel path TP (a target trajectory) from the entry area to the target parking space in the parking lot. The parking lot system 400 sends an entry instruction to the vehicle 100. The entry instruction includes information on the target parking space and the travel path TP. In response to the entry instruction, the vehicle 100 automatically travels to the target parking space along the travel path TP. That is, the vehicle 100 automatically travels so as to follow the travel path TP based on the vehicle position. Then, the vehicle 100 is automatically parked in the target parking space. Upon completion of the parking, the management system instructs the vehicle 100 to stop the operation.

An example of an exit process (check-out) is as follows. The user requests the exit by using the user terminal 200 or the like. The management system communicates with the vehicle 100 and activates the vehicle 100. At the time of exit, a designated exit area is a destination for the vehicle 100. The parking lot system 400 sets a travel path TP (a target trajectory) from the parking space to the exit area in the parking lot. The parking lot system 400 sends an exit instruction to the vehicle 100. The exit instruction includes information on the designated exit area and the travel path TP. In response to the exit instruction, the vehicle 100 automatically travels to the exit area along the travel path TP. That is, the vehicle 100 automatically travels so as to follow the travel path TP based on the vehicle position. Then, the vehicle 100 automatically stops the vehicle 100 in the exit area. The authority to operate the vehicle 100 is transferred from the management system to the user. The user gets on the vehicle 100. The vehicle 100 starts moving to a next destination.

### 2. Processing Related to Time Synchronization Request

### 2-1. Requirement for Vehicle

A vehicle clock CLK-VCL is an internal clock of the vehicle 100. That is, the vehicle clock CLK-VCL is a clock used in information processing inside the vehicle 100. On the other hand, a system clock CLK-RVO is an internal clock of the parking lot system 400. That is, the system clock CLK-RVO is a clock used in information processing inside the parking lot system 400. In the following description, "RVO" may be used to mean the parking lot system 400.

In the AVP, it is desired to know a relationship between the vehicle clock CLK-VCL and the system clock CLK-RVO. In particular, it is desirable that the parking lot system 400 knows the vehicle clock CLK-VCL in order to issue various instructions to the vehicle 100. For example, when a difference between the vehicle clock CLK-VCL and the system clock CLK-RVO is known, it is possible to know the vehicle clock CLK-VCL based on the difference and the system clock CLK-RVO. The parking lot system 400 according to the present embodiment transmits a request to the vehicle 100 in order to know the vehicle clock CLK-VCL. This request is hereinafter referred to as a "time synchronization request SYNC-REQ". It should be noted that such the request is also defined in Section 7.1.9 of Non-Patent Literature 1 mentioned above.

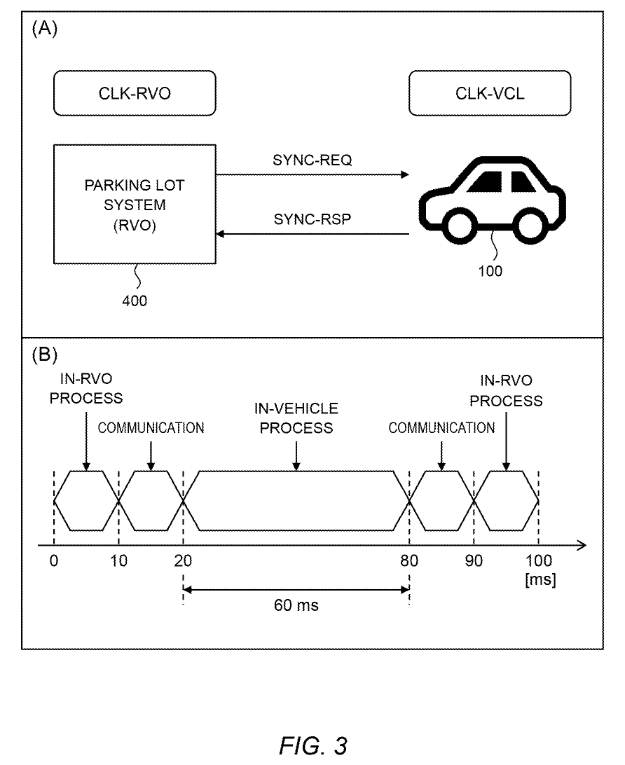

FIG. 3 is a conceptual diagram for explaining an outline of processing related to the time synchronization request SYNC-REQ. Exchange of information between the parking lot system 400 and the vehicle 100 is shown in a part (A) in FIG. 3.

First, the parking lot system 400 generates the time synchronization request SYNC-REQ and transmits the time synchronization request SYNC-REQ to the vehicle 100. In addition, the parking lot system 400 retains a value of the system clock CLK-RVO at the time of transmission of the time synchronization request SYNC-REQ as a transmission time stamp.

The vehicle 100 receives the time synchronization request SYNC-REQ transmitted from the parking lot system 400. The vehicle 100 processes the time synchronization request SYNC-REQ and generates a "time synchronization response SYNC-RSP". The the time synchronization response SYNC-RSP includes a value of the vehicle clock CLK-VCL as a vehicle time stamp. For example, the time synchronization response SYNC-RSP includes a value of the vehicle clock CLK-VCL at the time of generation of the time synchronization response SYNC-RSP as the vehicle time stamp. Then, the vehicle 100 returns the time synchronization response SYNC-RSP back to the parking lot system 400.

The parking lot system 400 receives the time synchronization response SYNC-RSP transmitted from the vehicle 100. In addition, the parking lot system 400 retains a value of the system clock CLK-RVO at the time of reception of the time synchronization response SYNC-RSP as a reception time stamp.

The parking lot system 400 calculates a round trip time (RTT) between the parking lot system 400 and the vehicle 100 based on the transmission time stamp and the reception time stamp. Moreover, the parking lot system 400 acquires the vehicle time stamp included in the received time synchronization response SYNC-RSP. Further, the parking lot system 400 calculates a difference between the vehicle clock CLK-VCL and the system clock CLK-RVO based on the vehicle time stamp and the RTT. Then, the parking lot system 400 knows the vehicle clock CLK-VCL based on the difference and the system clock CLK-RVO.

The parking lot system 400 may repeatedly generate and transmit the time synchronization request SYNC-REQ at every constant cycle. The constant cycle is, for example, a 100ms.

An example of processing times allocated to a series of processes is shown in a part (B) in FIG. 3 Each process is desired to be completed in less than the allotted processing time. For example, a processing time of the 10ms is allocated to the generation and transmission of the time synchronization request SYNC-REQ in the parking lot system 400. A processing time of the 10ms is allocated to the communication of the time synchronization request SYNC-REQ from the parking lot system 400 to the vehicle 100. A processing time of 60ms is allocated to the processing for the time synchronization request SYNC-REQ and the generation and transmission of the time synchronization response SYNC-RSP in the vehicle 100. A processing time of the 10ms is allocated to the communication of the time synchronization response SYNC-RSP from the vehicle 100 to the parking lot system 400. A processing time of the 10ms is allocated to the processing for the time synchronization response SYNC-RSP in the parking lot system 400.

As described above, it is desirable that the vehicle 100 quickly returns the time synchronization response SYNC-RSP in response to the time synchronization request SYNC-REQ from the parking lot system 400. In the above example, it is desirable that a time from the reception of the time synchronization request SYNC-REQ to the transmission of the time synchronization response SYNC-RSP is less than 60ms. In other words, it is desirable that the vehicle 100 transmits the time synchronization response SYNC-RSP in less than 60ms after receiving the time synchronization request SYNC-REQ.

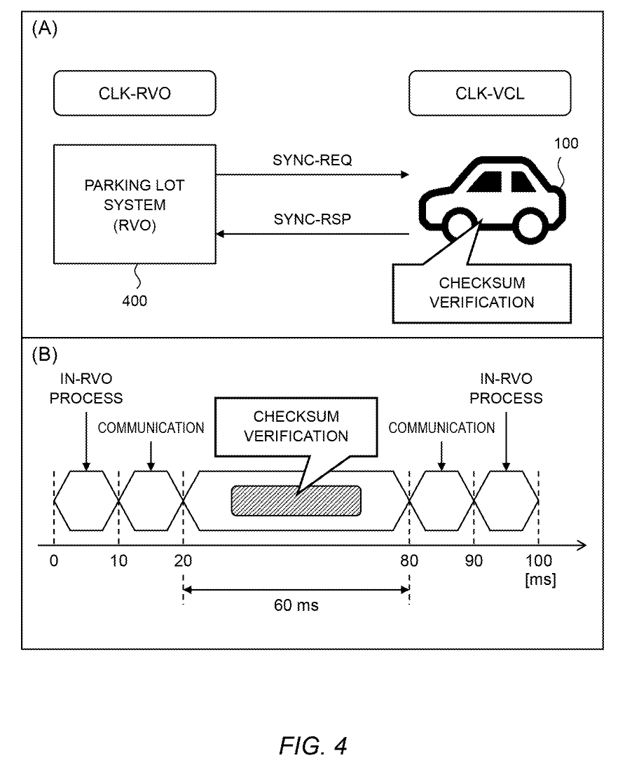

FIG. 4 is a conceptual diagram for explaining checksum verification of the time synchronization request SYNC-REQ. In order to verify certainty of the communication between the parking lot system 400 and the vehicle 100, it may be required for the vehicle 100 to verify the time synchronization request SYNC-REQ received from the parking lot system 400. More specifically, the vehicle 100 verifies the time synchronization request SYNC-REQ using a known error detection method. For example, a known cyclic redundancy check (CRC) is used for the error detection. Such the verification of the time synchronization request SYNC-REQ through the error detection is referred to as "checksum verification" for convenience. When an error in the time synchronization request SYNC-REQ is detected as a result of the checksum verification, the vehicle 100 notifies the parking lot system 400 of the detection. It should be noted that such the requirement is also defined in Section 7.5 of Non-Patent Literature 1 mentioned above.

The time from the reception of the time synchronization request SYNC-REQ to the transmission of the time synchronization response SYNC-RSP in the vehicle 100 includes a time required for the checksum verification. It is desirable that the vehicle 100 completes a series of in-vehicle processes including the checksum verification in less than a predetermined time (for example, 60ms).

### 2-2. In-Vehicle Process

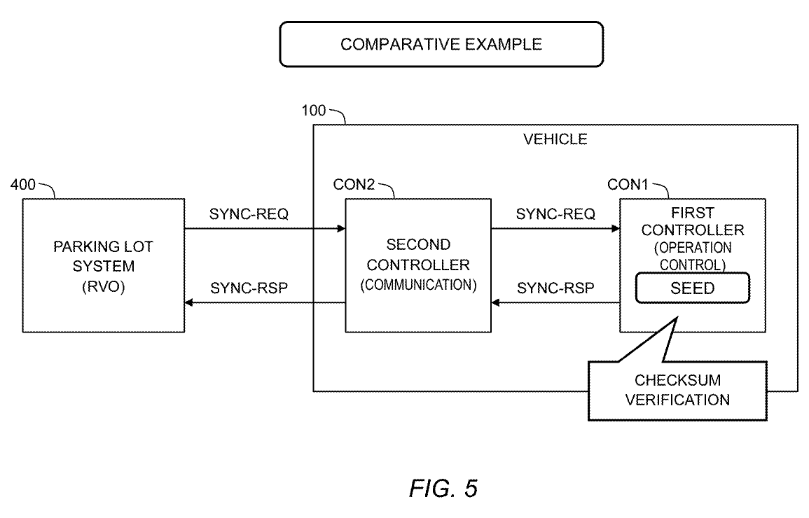

First, a comparative example of the in-vehicle process will be described with reference to FIG. 5. The vehicle 100 includes a first controller CON1 and a second controller CON2. The first controller CON1 and the second controller CON2 are capable of communicating with each other via an in-vehicle communication network.

The first controller CON1 is configured to control an operation of the vehicle 100. For example, the first controller CON1 automatically controls travel (at least one of driving, braking, and steering) of the vehicle 100 by controlling actuators of the vehicle 100. As another example, the first controller CON1 may automatically ON/OFF control a light in the vehicle 100. As still another example, the first controller CON1 may automatically open and close a door of the vehicle 100. An example of the first controller CON1 is an autonomous driving controller for controlling autonomous driving of the vehicle 100. The autonomous driving controller is also referred to as an autonomous driving electronic control unit (ECU). It should be noted that the first controller CON1 may be referred to as first processing circuitry.

The second controller CON2 is configured to receive information, which is transmitted from the parking lot system 400, before the first controller CON1. That is, the second controller CON2 is disposed on a communication path between the parking lot system 400 and the first controller CON1. In other words, the second controller CON2 is arranged to relay communication between the parking lot system 400 and the first controller CON1. The first controller CON1 receives information from the parking lot system 400 via the second controller CON2 and sends information to the parking lot system 400 via the second controller CON2. An example of the second controller CON2 is a communication controller for controlling wireless communication with the parking lot system 400. The communication controller is also referred to as a communication ECU. It should be noted that the second controller CON2 may be referred to as second processing circuitry.

In the comparative example shown in FIG. 5, the first controller CON1 executes the checksum verification and the like. For this purpose, the first controller CON1 retains information of a seed required in the checksum verification. For example, a known cyclic redundancy check (CRC) based on the seed is used for the error detection in the checksum verification (see Section 7.5 of Non-Patent Literature 1). The seed information is provided to the first controller CON1 in advance before reception of the time synchronization request SYNC-REQ.

The parking lot system 400 transmits the time synchronization request SYNC-REQ to the vehicle 100. The second controller CON2 of the vehicle 100 receives the time synchronization request SYNC-REQ. In the comparative example shown in FIG. 5, the second controller CON2 forwards the received time synchronization request SYNC-REQ to the first controller CON1. The first controller CON1 receives the time synchronization request SYNC-REQ from the second controller CON2. The first controller CON1 verifies the time synchronization request SYNC-REQ by performing the checksum verification based on the seed information retained therein. Further, the first controller CON1 generates the time synchronization response SYNC-RSP responding to the time synchronization request SYNC-REQ. The first controller CON1 transmits the time synchronization response SYNC-RSP to the second controller CON2. The second controller CON2 receives the time synchronization response SYNC-RSP from the first controller CON1. Then, the second controller CON2 forwards the time synchronization response SYNC-RSP to the parking lot system 400.

In the case of the comparative example shown in FIG. 5, a relatively long time is required for the series of in-vehicle processes including the checksum verification. For example, a communication between the first controller CON1 and the second controller CON2 is required, which increases the time required for the in-vehicle processes. Therefore, it may be difficult to complete the series of in-vehicle processes including the checksum verification in less than the predetermined time (for example, 60ms). That is, in the case of the comparative example shown in FIG. 5, it may be difficult to satisfy the requirement for the vehicle 100 described in the above Section 2-1.

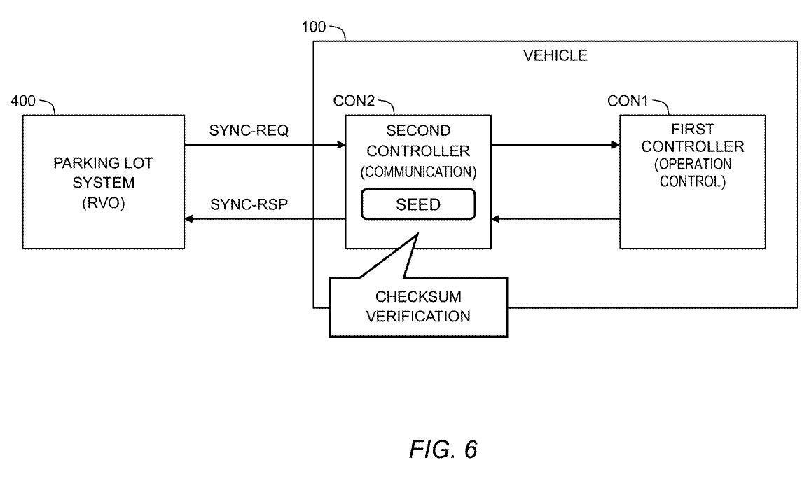

FIG. 6 is a conceptual diagram for explaining the in-vehicle process according to the present embodiment. According to the present embodiment, not the first controller CON1 but the second controller CON2 executes the checksum verification and the like. For that purpose, the second controller CON2 retains the seed information required in the checksum verification. As will be described later, the seed information is provided to the second controller CON2 in advance before reception of the time synchronization request SYNC-REQ.

The parking lot system 400 transmits the time synchronization request SYNC-REQ to the vehicle 100. The second controller CON2 of the vehicle 100 receives the time synchronization request SYNC-REQ. The second controller CON2 does not forward the time synchronization request SYNC-REQ to the first controller CON1. The second controller CON2 verifies the time synchronization request SYNC-REQ by performing the checksum verification based on the seed information retained therein. Further, the second controller CON2 generates the time synchronization response SYNC-RSP responding to the time synchronization request SYNC-REQ. Then, the second controller CON2 transmits the time synchronization response SYNC-RSP to the parking lot system 400.

As described above, according to the present embodiment, the time required for the series of in-vehicle processes including the checksum verification is shortened as compared with the case of the comparative example. That is, a time from the reception of the time synchronization request SYNC-REQ to the reply of the time synchronization response SYNC-RSP is shortened. Therefore, it becomes easy to complete the series of in-vehicle processes including the checksum verification in less than the predetermined time (for example, 60ms). That is, it is possible to more surely satisfy the requirement for the vehicle 100 described in the above Section 2-1.

### 2-3. Preparation of Seed Information

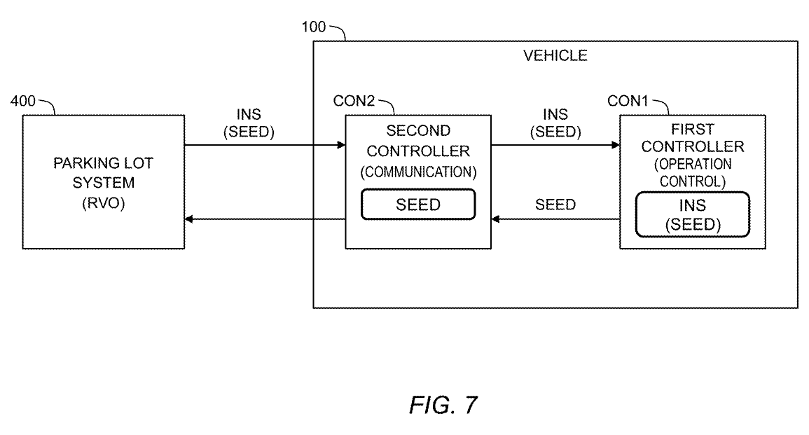

FIG. 7 is a conceptual diagram for explaining an example of preparation of the seed information. Before transmission of the time synchronization request SYNC-REQ, the parking lot system 400 transmits instruction information INS to the vehicle 100. For example, the instruction information INS includes an instruction related to an operation of the vehicle 100, that is, an instruction to the first controller CON1. The instruction information INS includes the seed information required in the checksum verification of the time synchronization request SYNC-REQ.

The second controller CON2 of the vehicle 100 receives the instruction information INS transmitted from the parking lot system 400 before the time synchronization request SYNC-REQ. The second controller CON2 forwards the received instruction information INS to the first controller CON1. The first controller CON1 receives the instruction information INS from the second controller CON2. The first controller CON1 performs processing in accordance with the instruction indicated by the instruction information INS. Meanwhile, the first controller CON1 extracts the seed information included in the instruction information INS and transmits the seed information to the second controller CON2. The second controller CON2 receives the seed information from the first controller CON1 and retains the received seed information. In this manner, the second controller CON2 is able to acquire and retain the seed information required in the checksum verification, before receiving the time synchronization request SYNC-REQ.

As a modification example, the second controller CON2 may directly extract the seed information from the instruction information INS received from the parking lot system 400. Also in this case, the second controller CON2 is able to acquire and retain the seed information before receiving the time synchronization request SYNC-REQ.

### 2-4. In-Vehicle Communication Verification Process

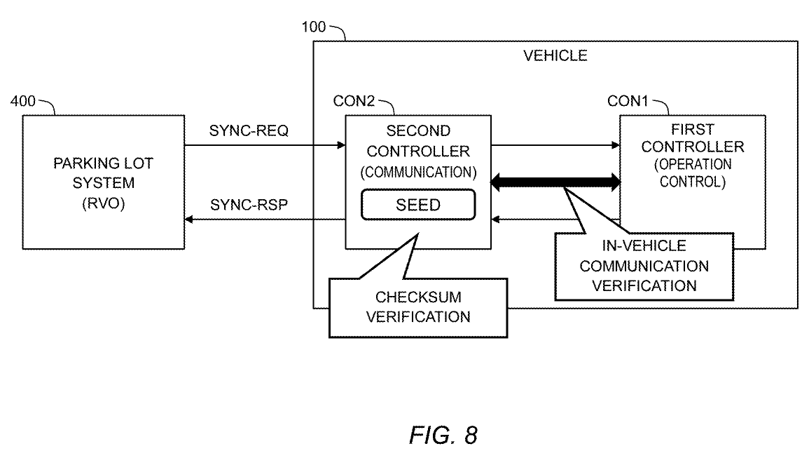

FIG. 8 is a conceptual diagram for explaining an in-vehicle communication verification process. As described above, when the second controller CON2 receives the time synchronization request SYNC-REQ from the parking lot system 400, the second controller CON2 performs the checksum verification of the time synchronization request SYNC-REQ. The checksum verification of the time synchronization request SYNC-REQ makes it possible to verify the certainty of the communication between the parking lot system 400 and the second controller CON2. However, only with this, certainty of an in-vehicle communication between the first controller CON1 and the second controller CON2 is not yet verified.

In view of the above, when the second controller CON2 receives the time synchronization request SYNC-REQ from the parking lot system 400, the first controller CON1 and the second controller CON2 may verify certainty of the in-vehicle communication between the first controller CON1 and the second controller CON2. This process is referred to as an "in-vehicle communication verification process". For example, when the second controller CON2 receives the time synchronization request SYNC-REQ from the parking lot system 400, the second controller CON2 executes the series of in-vehicle processes described above and requests the first controller CON1 to start the in-vehicle communication verification process. A method of the in-vehicle communication verification process is not particularly limited. For example, the first controller CON1 and the second controller CON2 are connected to each other via the Ethernet, and the in-vehicle communication verification process is performed using an error detection method generally used in the Ethernet.

### 3. Cooperation with Vehicle Identification Process

Consider identifying a specific vehicle 100 in the parking lot. A vehicle 100 to be identified is hereinafter referred to as "target vehicle 100T". A process of identifying the target vehicle 100T in the parking lot is hereinafter referred to as a "vehicle identification process".

For example, the target vehicle 100T is an entry vehicle that tries to enter the parking lot using the AVP service. For example, when a first vehicle of a first user is to enter the parking lot by using the AVP service, the first vehicle is the target vehicle 100T. More specifically, the first vehicle stops in the entry area. The first user gets off the first vehicle and requests AVP initiation. In initiating the AVP for the first vehicle, it is desirable for the parking lot system 400 to know exactly which vehicle 100 in the entry area is the first vehicle. That is, it is desirable that the parking lot system 400 identifies the first vehicle (i.e., the target vehicle 100T). Identifying the first vehicle makes it possible to accurately recognize a position of the first vehicle, that is, a start position of the automated travel. In addition, it is possible to prevent another vehicle 100 different from the first vehicle from entering by mistake.

In the present embodiment, an "action" executed by the target vehicle 100T is used for the vehicle identification process. An action is defined by a combination of a device that executes the action and an operation pattern of the device. Examples of a visible actions include turning on a light, flashing a light, flashing a blinker, operating a wiper, opening and closing a door, opening and closing a window, opening and closing a door mirror, opening and closing an engine hood, and so forth. Examples of an audible action include sounding a horn, driving an engine, and so forth. For example, a head light or a blinker flashes in a predetermined pattern for a predetermined period of time (e.g., several seconds). As another example, a door mirror may open and close in a predetermined pattern for a predetermined period of time. As yet another example, the horn may sound in a predetermined pattern for a predetermined period of time. The action of a predetermined pattern may be executed repeatedly in time.

The parking lot system 400 instructs the target vehicle 100T to execute a predetermined action. More specifically, the parking lot system 400 transmits an action instruction that instructs execution of the predetermined action to the target vehicle 100T. For example, the action instruction includes the content of the predetermined action assigned to the target vehicle 100T. The target vehicle 100T receives the action instruction from the parking lot system 400. The target vehicle 100T execute the predetermined action in response to the action instruction.

One or more infrastructure sensors for recognizing (detecting) the action are disposed in the parking lot. For example, the infrastructure sensor includes a camera for recognizing (detecting) the visible action. As another example, the infrastructure sensor may include a microphone for recognizing (detecting) the audible action. The parking lot system 400 is able to recognize (detect) an action performed by any vehicle 100 in the parking lot by using the infrastructure sensor. It is assumed that execution of the predetermined action by a certain vehicle 100 is recognized (detected) within a predetermined determination period after the action instruction is transmitted. In this case, the parking lot system 400 identifies the certain vehicle 100 as the target vehicle 100T. That is, the parking lot system 400 identifies, as the target vehicle 100T, a vehicle 100 that has executed the predetermined action within the predetermined determination period.

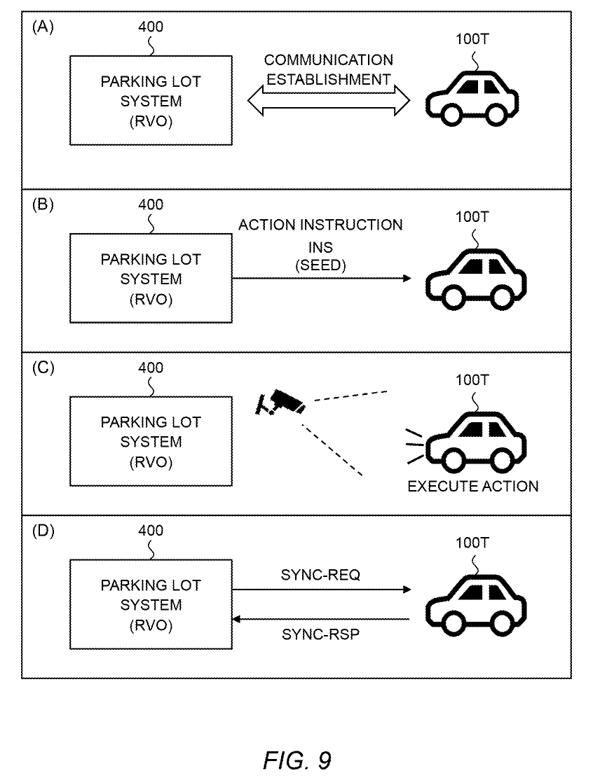

FIG. 9 is a conceptual diagram illustrating an example of a cooperation between the vehicle identification process and the processes related to the time synchronization request SYNC-REQ.

First, as shown in [A] in FIG. 9, the parking lot system 400 and the target vehicle 100T establish a communication.

Subsequently, as shown in [B] in FIG. 9, the parking lot system 400 transmits the instruction information INS to the target vehicle 100T. The instruction information INS includes the action instruction that instructs the target vehicle 100T to execute the predetermined action. The predetermined action is, for example, blinking of a light. It can be said that the action instruction is an instruction related to the operation of the target vehicle 100T, that is, an instruction to the first controller CON1. The instruction information INS also includes the seed information required in the checksum verification of the time synchronization request SYNC-REQ. At this stage, the second controller CON2 of the target vehicle 100T acquires and retains the seed information required in the checksum verification (see FIG. 7).

As shown in [C] in FIG. 9, the target vehicle 100T executes the predetermined action in response to the action instruction. More specifically, the first controller CON1 of the target vehicle 100T receives the instruction information INS via the second controller CON2 (see FIG. 7). The first controller CON1 of the target vehicle 100T makes the target vehicle 100T execute the predetermined action in response to the action instruction. The parking lot system 400 executes the vehicle identification process by using the infrastructure sensor. That is, the parking lot system 400 identifies, as the target vehicle 100T, a vehicle 100 that has executed the predetermined action within the predetermined determination period.

After the vehicle identification process, as shown in [D] in FIG. 9, the parking lot system 400 transmits the time synchronization request SYNC-REQ to the target vehicle 100T. The second controller CON2 of the target vehicle 100T executes the series of in-car processes including the checksum verification in response to the time synchronization request SYNC-REQ (see FIG. 6 above). The seed information acquired in advance at the stage of the vehicle identification process described above is used for the checksum verification.

### 4. Configuration Example of Vehicle

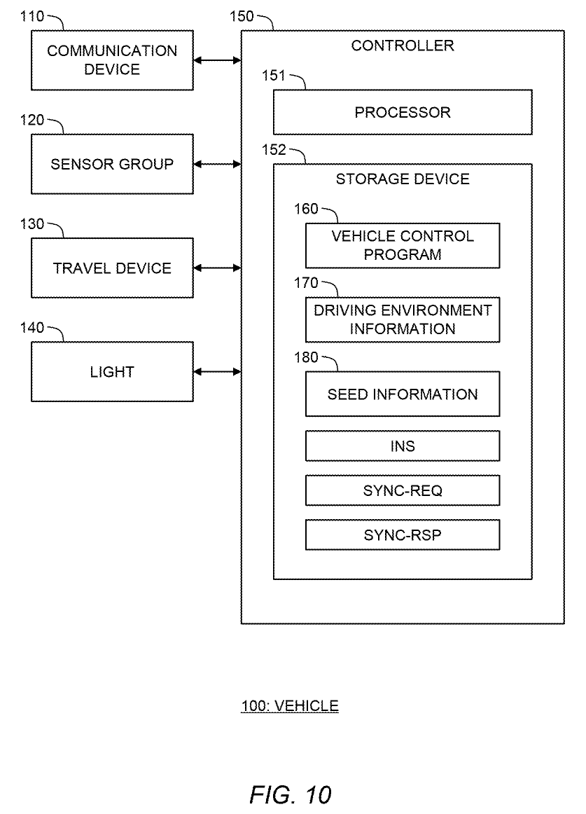

FIG. 10 is a block diagram showing a configuration example of the vehicle 100 according to the present embodiment. The vehicle 100 includes a communication device 110, a sensor group 120, a travel device 130, a light 140, and a controller 150.

The communication device 110 includes an antenna and a transmission/reception circuit.

The sensor group 120 includes a recognition sensor, a vehicle state sensor, and the like. The recognition sensor is used for recognizing (detecting) a situation around the vehicle 100. Examples of the recognition sensor include a camera, a laser imaging detection and ranging (LIDAR), a radar, and the like. The vehicle state sensor includes a speed sensor, an acceleration sensor, a yaw rate sensor, a steering angle sensor, and the like.

The travel device 130 includes a steering device, a driving device, and a braking device. The steering device turns wheels. For example, the steering device includes an electric power steering (EPS) device. The driving device is a power source that generates a driving force. Examples of the driving device include an engine, an electric motor, an in-wheel motor, and the like. The braking device generates a braking force.

Examples of the light 140 include a blinker (direction indicator), a headlight, a brake light, a fog light, and the like.

The controller 150 is a computer that controls the vehicle 100. The controller 150 includes one or more processors 151 (hereinafter, simply referred to as a processor 151) and one or more storage devices 152 (hereinafter, simply referred to as a storage device 152). The processor 151 executes a variety of processing. Examples of the processor 151 include a general-purpose processor, a special-purpose processor, a central processing unit (CPU), a graphics processing unit (GPU), an application specific integrated circuit (ASIC), a field-programmable gate array (FPGA), an integrated circuit, and / or a combination thereof. The processor 151 may also be referred to as processing circuitry. The storage device 152 stores a variety of information. Examples of the storage device 152 include a volatile memory, a nonvolatile memory, a hard disk drive (HDD), a solid state drive (SSD), and the like.

A vehicle control program 160 is a computer program for controlling the vehicle 100. The functions of the controller 150 may be realized by a cooperation between the processor 151 executing the vehicle control program 160 and the storage device 152. The vehicle control program 160 is stored in the storage device 152. Alternatively, the vehicle control program 160 may be recorded on a non-transitory computer-readable recording medium.

The controller 150 communicates with the back-end system 300 and the parking lot system 400 via the communication device 110.

The controller 150 executes vehicle travel control for controlling travel of the vehicle 100. The vehicle travel control includes steering control, acceleration control, and deceleration control. The controller 150 executes the vehicle travel control by controlling the travel device 130 (i.e., the steering device, the driving device, and the braking device).

In addition, the controller 150 ON/OFF controls the light 140.

Moreover, the controller 150 acquires driving environment information 170 indicating a driving environment for the vehicle 100. The driving environment information 170 is stored in the storage device 152. For example, the driving environment information 170 includes surrounding situation information, vehicle state information, map information, position information, and the like.

The surrounding situation information indicates the result of recognition by the recognition sensor. The surrounding situation information may include object information regarding an object recognized by the recognition sensor. Examples of the object around the vehicle 100 include an obstacle, a white line, a marker M, and the like. Examples of the obstacle include a wall, a pillar, another vehicle, and the like. The object information indicates a relative position and a relative speed of the object with respect to the vehicle 100.

The vehicle state information indicates the vehicle state detected by the vehicle state sensor. Examples of the vehicle state include a speed, an acceleration, a yaw rate, a steering angle, and the like.

The map information is map information of the parking lot in which the vehicle 100 travels. The map information indicates an arrangement of roads in the parking lot. In addition, the map information indicates an arrangement of stationary obstacles (for example, walls and pillars) in the parking lot. The map information further indicates an arrangement of the markers M in the parking lot. For example, the map information is provided from the parking lot system 400 that manages the parking lot. The controller 150 acquires the map information from the parking lot system 400.

The position information indicates a current position of the vehicle 100 in the parking lot. For example, the controller 150 acquires the position information with high accuracy by performing localization processing (localization). More specifically, the controller 150 calculates a rough position of the vehicle 100 in the parking lot based on the vehicle state information (specifically, the steering angle and the speed). Moreover, the controller 150 recognizes the marker M around the vehicle 100 by using the recognition sensor. In addition, the controller 150 acquires the arrangement information of the markers M around the vehicle 100 from the map information. The controller 150 corrects the position of the vehicle 100 by matching the recognition result of the marker M with the arrangement of the markers M. Accordingly, the position information with high accuracy is obtained.

Alternatively, the position information of the vehicle 100 may be estimated by the parking lot system 400 based on the image captured by the infrastructure camera CAM. In this case, the controller 150 may acquire the position information from the parking lot system 400.

Further, the controller 150 acquires information on the travel path TP in the parking lot. For example, the travel path TP is determined by the parking lot system 400, and the controller 150 acquires information on the travel path TP from the parking lot system 400. As another example, the controller 150 may determine the travel path TP based on the map information and the position information. Then, the controller 150 executes the vehicle travel control based on the position information such that the vehicle 100 travels along the travel path TP.

The controller 150 includes the first controller CON1 and the second controller CON2.

The first controller CON1 acquires the driving environment information 170. Moreover, the first controller CON1 executes the vehicle travel control. The first controller CON1 may receive the instruction information INS. The first controller CON1 may control the vehicle 100 to execute a predetermined action. For example, the first controller CON1 ON/OFF controls the light 140.

The second controller CON2 receives the instruction information INS from the parking lot system 400 via the communication device 110. The instruction information INS includes the seed information 180 necessary for the checksum verification. The seed information 180 is stored in advance in the storage device 152 of the second controller CON2. The second controller CON2 receives the time synchronization request SYNC-REQ from the parking lot system 400 via the communication device 110. In response to the time synchronization request SYNC-REQ, the second controller CON2 executes a series of in-vehicle processes including the checksum verification. The seed information 180 stored in advance in the storage device 152 is used for the checksum verification with respect to the time synchronization request SYNC-REQ. The second controller CON2 generates the time synchronization response SYNC-RSP. The second controller CON2 transmits the time synchronization response SYNC-RSP to the parking lot system 400 via the communication device 110.

### 5. Configuration Example of Parking Lot System

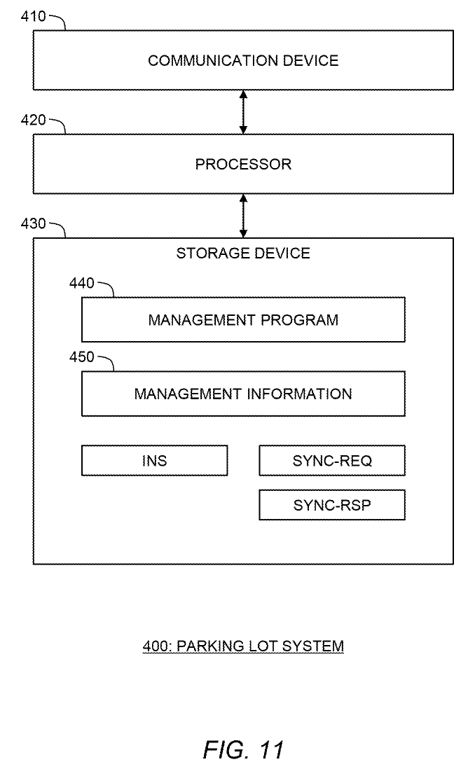

FIG. 11 is a block diagram showing a configuration example of the parking lot system 400 according to the present embodiment. The parking lot system 400 includes a communication device 410, one or more processors 420 (hereinafter simply referred to as a processor 420), and one or more storage devices 430 (hereinafter simply referred to as a storage device 430).

The communication device 410 communicates with each vehicle 100. In addition, the communication device 410 communicates with the back-end system 300. Further, the communication device 410 may communicate with the infrastructure camera CAM installed in the parking lot.

The processor 420 executes a variety of processing. Examples of the processor 420 include a general purpose processor, a special purpose processor, a CPU, a GPU, an ASIC, an FPGA, an integrated circuit, and / or combinations thereof. The processor 420 may also be referred to as processing circuitry. The storage device 430 stores a variety of information. Examples of the storage device 430 include a volatile memory, a nonvolatile memory, an HDD, an SSD, and the like.

A management program 440 is a computer program for managing the parking lot. The functions of the parking lot system 400 may be realized by a cooperation between the processor 420 executing the management program 440 and the storage device 430. The management program 440 is stored in the storage device 430. The management program 440 may be recorded on a non-transitory computer-readable recording medium.

The processor 420 communicates with the vehicle 100 and the back-end system 300 via the communication device 410. The processor 420 may also communicate with the user terminal 200 via the communication device 410 and the back-end system 300.

The storage device 430 stores management information 450 for managing the parking lot. The management information 450 includes the map information of the parking lot. The processor 420 may provide the map information to the vehicle 100 via the communication device 410. Moreover, the management information 450 indicates a usage status (vacancy status) of the parking spaces in the parking lot. The processor 420 can allocate an available parking space (destination) to the vehicle 100 based on the management information 450.

The management information 450 may further include vehicle management information. The vehicle management information includes the position information of each vehicle 100 in the parking lot. The processor 420 may communicate with each vehicle 100 via the communication device 410 and collect the position information from each vehicle 100. Alternatively, the processor 420 may acquire the image captured by the infrastructure camera CAM installed in the parking lot and estimate the position of each vehicle 100 based on the image. The vehicle management information may include the travel path TP allocated to each vehicle 100. The processor 420 can determine the travel path TP allocated to each vehicle 100 based on the position information 174 the vehicle 100, the destination, and the map information. The processor 420 may provide the information on the travel path TP to the vehicle 100 via the communication device 410.

The processor 420 transmits the instruction information INS to the vehicle 100 via the communication device 410. The instruction information INS includes the seed information 180 necessary for the checksum verification in the vehicle 100. In, addition, the processor 420 transmits the time synchronization request SYNC-REQ to the vehicle 100 via the communication device 410. The processor 420 receives the time synchronization response SYNC-RSP from the vehicle 100 via the communication device 410.

What is claimed is:

1. A vehicle that supports automated valet parking in a parking lot,
the vehicle comprising:
a first controller configured to control an operation of the vehicle; and
a second controller configured to receive information, which is transmitted from a parking lot system that manages the automated valet parking in the parking lot, before the first controller, wherein
a time synchronization request is a request transmitted from the parking lot system to the vehicle in order to know a clock of the vehicle,
the second controller acquires and retains seed information before reception of the time synchronization request, the seed information being required in error detection for verification of the time synchronization request, and
the second controller is configured to, upon receiving the time synchronization request from the parking lot system, verify the time synchronization request through the error detection based on the seed information and return a response to the time synchronization request back to the parking lot system.

2. The vehicle according to claim 1, wherein
the second controller is configured to verify the time synchronization request and return the response to the time synchronization request to the parking lot system, without forwarding the time synchronization request to the first controller.

3. The vehicle according to claim 1, wherein
the second controller is a communication controller that controls wireless communication with the parking lot system.

4. The vehicle according to claim 1, wherein
when the second controller receives the time synchronization request from the parking lot system, the first controller and the second controller are configured to verify certainty of an in-vehicle communication between the first controller and the second controller.

5. The vehicle according to claim 1, wherein
the second controller is further configured to receive instruction information transmitted from the parking lot system before the time synchronization request, and
the seed information is included in the instruction information.

6. The vehicle according to claim 5, wherein
the instruction information includes an instruction to the first controller.

7. The vehicle according to claim 6, wherein
the second controller is further configured to forward the instruction information to the first controller,
the first controller is configured to receive the instruction information from the second controller and transmit the seed information included in the instruction information to the second controller, and
the second controller is further configured to retain the seed information received from the first controller.

8. The vehicle according to claim 6, wherein
the instruction information includes an action instruction that instructs the vehicle to execute a predetermined action, and
the first controller is configured to make the vehicle execute the predetermined action in response to the action instruction.
